(19) United States
(12) Patent Application Publication
(10) Pub. No.: US 2009/0225755 A1
(43) Pub. Date: Sep. 10, 2009

(54) Method And System For Forwarding An MPLS Packet

(76) Inventors: Jian Wu, Guangdong Province (CN); Yi Wang, Guangdong Province (CN); Dapeng Zhang, Guangdong Province (CN)

Correspondence Address: LADAS & PARRY LLP, 26 WEST 61ST STREET, NEW YORK, NY, 10023, US

(21) Appl. No.: 11/791,596

(22) PCT Filed: Sep. 19, 2006
(86) PCT No.: PCT/CN2006/002450

§ 371 Date: May 24, 2007

(30) Foreign Application Priority Data
Feb. 17, 2006 (CN) 200610033763.1

(51) Int. Cl. H04L 12/56

(52) U.S. Cl. 370/392

(57) ABSTRACT

A method and a device for forwarding an MPLS packet, the method comprising: allocating a private MAC address to a port number of the MPLS packet interface board, and establishing a correlation between the private MAC address and the public MAC address; obtaining the private MAC address and the port number corresponding to a destination public MAC address of the MPLS packet according to the correlation; substituting the private MAC address for the public MAC address in the MPLS packet; forwarding the MPLS packet to the corresponding port according to the private MAC address. The device comprises: an MPLS packet interface board arranged in an ether switching device, for providing a dedicated interface for MPLS packet forwarding; and a MAC address converting module, for converting between the public MAC address in the MPLS packet and the private MAC address in the ether switching device.

### FIELD OF THE INVENTION

The present invention relates to the technical field of network communications, in particular, to a method and a device for forwarding MPLS (Multi-Protocol Label Switching) packets in an ether switching device.

### BACKGROUND OF THE INVENTION

With the development of Ethernet technologies, the cost of Ethernet switching devices decreases drastically. As a result, Ethernet switching devices are widely used in enterprise networks. Due to the enhancement of the performance, security and manageability of Ethernet, the scale and coverage area of Ethernet increase by leaps and bounds. Ether technology has become one of the most important and prevailing solutions in the access network, the access bearer network and even the backbone network. In the conventional backbone network, MPLS (Multi-Protocol Label Switching) may be employed, and IP/MPLS technologies may also be used as a preferred solution to replace ATM (Asynchronous Transfer Mode) technology. In such a case, MPLS technology is shifted downward to the access network and the access bearer network, borne over layer-2 Ethernet, and provides connection-oriented service channels, so that it's possible to provide an end-to-end systematic solution to users and services.

For a conventional access bearer network constructed with Ethernet switch, in the present solution, ether addresses of all of the users related must be learned, thus the stability and expandability of the network are limited. After MPLS (Multi-Protocol Label Switching) technology is employed, by establishing LSP (Label Switch Path) in the access bearer network, data forwarding between each switching node can be realized with MPLS label switch. The layer-2 MAC address in user's ether data header is packaged in an MPLS label, and the MAC address of a user packet does not need to be learned on a carrier equipment node of the access bearer network. Therefore, it may be avoided to learn a great number of user MAC (Media Access Control) addresses in the carrier network, so that the stability, scalability and security of the network may be improved.

At present, MPLS is widely used in routing switching devices based on layer-3 IP network, for providing users with various services, such as PWE3 (Pseudo Wire Emulation End to End), L2VPN (Layer-2 Virtual Private Network), MPLS traffic engineering and so on. Therefore, the MPLS label has excellent flexibility and expandability, together with the inherent security of LSP switch, it bears more and more services in a packet switching network. When MPLS technology is employed in conjunction with an ether switch hardware platform and the switching network board used in the switch is an ether switch chip, only layer-2 ether packets can be supported in the switching Ethernet, and packets such as ATM, MPLS and so on cannot be supported directly. As a result, when a layer-2 ether switch chip has to be used as an internal switching hardware of a switching device, no further value-added services can be provided in the prior art.

### SUMMARY OF THE INVENTION

Therefore, the embodiments of the invention provide a method and a device for forwarding an MPLS packet, so that the MPLS packet can be forwarded in a universal ether switching device.

A method for forwarding an MPLS packet in an ether switching device according to the invention, including:

allocating a private MAC (Media Access Control) address to a port number of an MPLS packet interface board, and establishing a correlation between the private MAC address and a public MAC address;

obtaining a private MAC address and a port number corresponding to a destination public MAC address of an MPLS packet according to the correlation;

substituting the private MAC address for the public MAC address in the MPLS packet;

forwarding the MPLS packet to the corresponding port according to the private MAC address; and

substituting the destination public MAC address for the private MAC address in the MPLS packet, and forwarding the MPLS packet normally.

The process of establishing a correlation between the private MAC address and the public MAC address comprises:

configuring a mapping table of the port number, the private MAC address and the public MAC address.

Wherein, the private MAC address is a reserved MAC address.

More preferably, before substituting the private MAC address for the public MAC address in the MPLS packet, it is determined whether MPLS label switching is required to be performed on the MPLS packet, if yes, then perform the corresponding MAC address substitution; otherwise, forward the original ether packet normally.

More preferably, after the corresponding MAC address substitution is performed, VLAN information is packaged in the MPLS packet; and

after the public MAC address is substituted for the private MAC address in the MPLS packet, the VLAN information is unpackaged from the MPLS packet.

There is further provided a device for forwarding an MPLS packet in an ether switching device, comprising:

an MPLS packet interface board arranged in an ether switching device, for providing a dedicated interface for MPLS packet forwarding;

a MAC address converting module, for performing conversion between the public MAC address in an MPLS packet that enters the MPLS packet interface board and the private MAC address in an ether switching device;

when an MPLS packet enters the ether switching device via the MPLS packet interface board, the MAC address converting module substitutes a private MAC address for a public MAC address in the MPLS packet, and an ether switch chip forwards the MPLS packet to a corresponding port according to the private MAC address; the MAC address converting module substitutes the destination public MAC address for the private MAC address in the MPLS packet, so as to forward it normally.

The MAC address converting module is embedded in the MPLS packet interface board.

More preferably, the device further comprises:

an MPLS packet switching confirmation module, for confirming whether MPLS label switching is required to be performed on the MPLS packet;

a VLAN packaging module, for packaging VLAN information into an MPLS packet; and

a VLAN unpackaging module, for unpackaging the VLAN information packaged in the MPLS packet.

Preferably, the MPLS packet interface board has at least one service port, and each service port is configured with a MAC address.

Preferably, the MAC address is a private MAC address.

Preferably, the ether switch chip is a layer-2 ether switch chip or a layer-3 ether switch chip.

It can be seen from the above technical solution of the invention that by configuring an MPLS packet interface board in an ether switching device, a private MAC address is allocated to a port number of the MPLS packet interface board, and a correlation between the private MAC address and the public MAC address is established; the private MAC address and the port number corresponding to a destination public MAC address of an MPLS packet are obtained; the private MAC address is substituted for the public MAC address in the MPLS packet; and the MPLS packet is forwarded to the corresponding port according to the private MAC address, so that MPLS packet forwarding can be realized on layer-2 and layer-3 ether switch chips. According to the invention, various services based on MPLS, such as PWE3, L2VPN, MPLS traffic engineering and so on, can be supported on layer-2 and layer-3 ether switch chips.

### BRIEF DESCRIPTION OF THE DRAWINGS

FIG. 1 is a flow chart of a method according to an embodiment of the invention;

FIG. 2 is a schematic diagram showing the system structure of an embodiment of the invention;

FIG. 3 is a schematic diagram showing the internal structure of an MPLS packet interface board according to an embodiment of the invention;

FIG. 4 is a flow chart in which an MPLS packet enters an interface according to an embodiment of the invention; and

FIG. 5 is a flow chart in which an MPLS packet exits an interface according to an embodiment of the invention.

### DETAILED DESCRIPTION OF THE EMBODIMENTS

The embodiments of the invention provide a device and a method for forwarding an MPLS packet in an ether switching device. In an embodiment of the invention, an MPLS packet interface board is added in an ether switching device, wherein the MPLS packet interface board has at least one service port, and a MAC address is allocated to each service port. The MAC address may be a private MAC address, which has no conflict with the common public MAC addresses for normal forwarding. When an MPLS packet enters the ether switching device, the MPLS packet interface board packages a private MAC address into the packet, and an ether switch chip in the ether switching device forwards the packet to a port corresponding to the destination public MAC address according to the private MAC address, so that MPLS packet forwarding may be realized in the ether switching device. The ether switch chip is a layer-2 ether switch chip or a layer-3 ether switch chip.

To make the objects, the technical solution and the advantages of the invention more apparent, the invention will now be illustrated in detail in conjunction with the drawings and preferred embodiments.

When an MPLS packet needs to be forwarded via an ether switching device, because the internal ether switch chip of the ether switching device only identifies the MAC address, the MPLS packet cannot be forwarded in the ether switching device. As a result, MPLS packet switching cannot be realized by simply adapting the driver of the ether chip.

The structure of an MPLS packet with ether package is as follows:

CRC
Load
Mpls Lable
Vlan-Tag (Optional)
S-MAC
D-MAC

Therefore, during the implementation of the invention, a private MAC address is to be allocated to each port of an MPLS packet interface board at first, then a MAC address configuration table of the correlation between the private MAC address and the public MAC address is configured, wherein the table is needed for converting the MAC address. For example, a MAC address mapping table can be configured, the table item is:

| MPLS PACKET | | | |
|---|---|---|---|
| INTERFACE | | | |
| BOARD | PORT | PRIVATE MAC | PUBLIC MAC |
| IDENTIFICATION | NUMBER | ADDRESS | ADDRESS |
| 100 | Ge1/0/1 | 0001-0002-0003 | 0004-0005-0006 |

Thus, a private MAC address is allocated to each port number of the MPLS packet interface board, and the public MAC address connected with the port is shown in the table item.

MPLS packet forwarding is mainly accomplished via label switching. The MPLS packet obtains the out-label, the corresponding IP address and the public MAC address information needed by searching the in-label mapping table ILM. To realize MPLS packet forwarding in an ether switching device, a MAC address converting module may be added, so that the MAC Address item in the ILM table may be converted between the private MAC address and the public MAC address. Specifically, when an MPLS packet enters the ether switching device for forwarding, the MPLS packet interface board searches the MAC address mapping table according to the destination public MAC address of the packet, so that the port corresponding to the destination public MAC address and the private MAC address corresponding to the port can be obtained. The MAC address converting module converts the public MAC address of the packet into the private MAC address needed. Then, the packet enters the ether switch chip for forwarding. When the packet reaches the destination port, the MAC address converting module queries the MAC address mapping table again, and converts the private MAC address in the ILM table into the public MAC address, so that the MPLS packet can be forwarded in the ether switching device. The specific configuration of the ILM table may be shown as follows:

IN-LABEL
OUT-LABEL
NEXT HOP IP ADDRESS
MAC ADDRESS ITEM
.
.
.

Therefore, there is provided a device for forwarding an MPLS packet in an ether switching device in an embodiment of the invention. The device comprises an MPLS packet interface board, which is used to provide a dedicated interface board for realizing MPLS packet forwarding in an ether switching device. The MPLS packet interface board is set in the ether switching device and has at least one service port, and a MAC address is allocated to each service port. The MAC address has no conflict with the common public MAC addresses for normal forwarding; for example, it may employ a private MAC address. The device of the invention further comprises a MAC address converting module, for performing conversion between the public MAC address and the private MAC address in the ether switching device. The MAC address converting module can be embedded in the MPLS packet interface board.

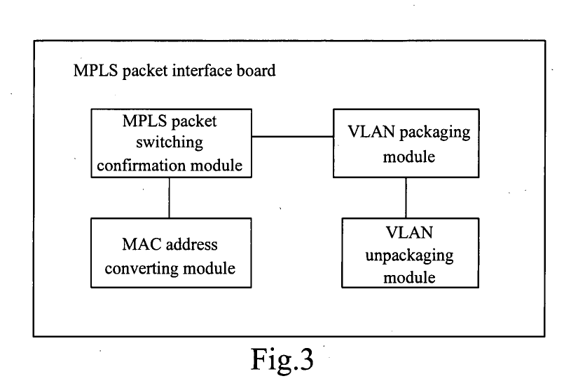

The device for forwarding an MPLS packet according to an embodiment of the invention further comprises a VLAN packaging module and a VLAN unpackaging module, as shown in FIG. 3, which may be arranged in the MPLS packet interface board. The VLAN packaging module is used for packaging a VLAN (Virtual LAN) information into an MPLS packet entering the MPLS packet interface board; since a layer-2 switch chip usually performs forwarding based on VLAN and MAC information, the VLAN information needs to be packaged. Correspondingly, when the MPLS packet exits the MPLS packet interface board, a VLAN unpackaging module needs to be provided for unpackaging the VLAN information packaged. Additionally, in a specific embodiment, for some MPLS packets entering the MPLS packet interface board, MPLS packet switching is not required to be performed in the subsequent forwarding process. Therefore, the device for forwarding an MPLS packet according to an embodiment of the invention may further comprise an MPLS packet switching confirmation module, for determining whether MPLS switching is required to be performed on an MPLS packet entering the MPLS packet interface board. If yes, then as described above, the MPLS packet may be forwarded in the ether switching device via the MAC address converting module and the ether switch chip; otherwise, the ether header and MPLS label in the outer-layer may be stripped off from the MPLS packet, so that the original ether packet is sent to the ether switch chip for normal forwarding.

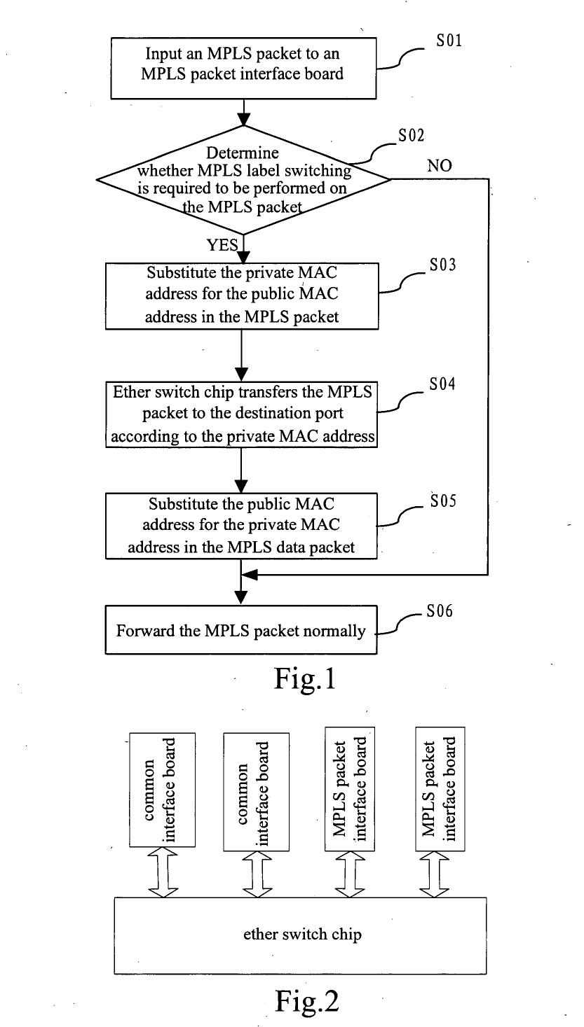

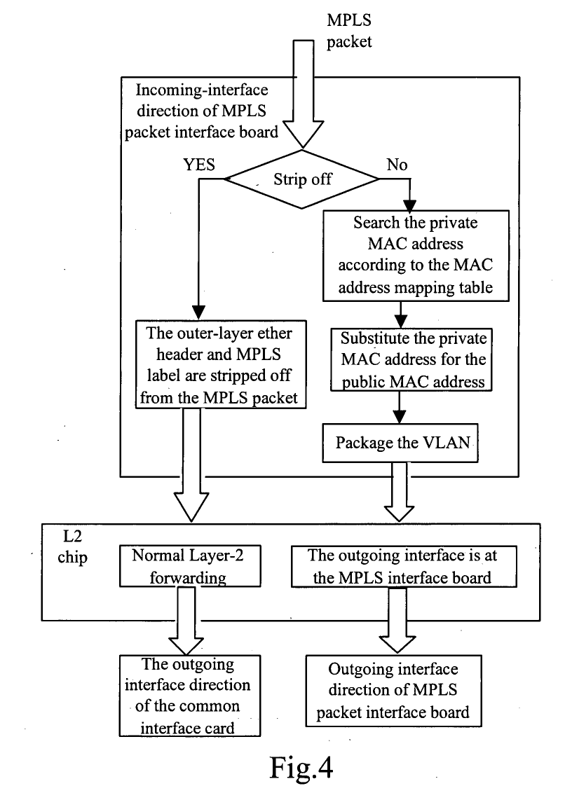

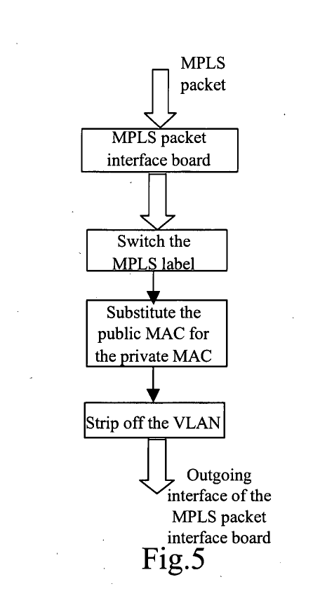

For better understanding of the invention, the implementing process of an embodiment of the invention is hereinafter described in detail, referring to FIG. 1, FIG. 4 and FIG. 5.

Step S01: Input an MPLS packet to an MPLS packet interface board;

In the embodiments of the invention, no special configuration is required to be performed on MPLS packet, because it has been specified in the MPLS Standard Protocol that when the package protocol number in the ether packet header is 8847, it means that this is an MPLS packet, which needs to be sent to an MPLS module for processing. Thus, when an MPLS packet enters an ether switching device, it is required to enter an MPLS packet interface board.

Step S02: it is determined whether MPLS label switching is required to be performed on the MPLS packet, if yes, turn to Step S03; otherwise, turn to Step S06.

In the embodiments of the invention, during the subsequent forwarding process, MPLS label switching is not required to be performed on some MPLS packets entering the MPLS packet interface board. In general, if two or more layers of label stacks are packaged in an MPLS packet, it is determined whether MPLS label switching is required to be performed according to label processing methods such as Push, Pop and Swap, as well as the flag of the label stack bottom. Therefore, there is further provided an MPLS packet switching confirmation module, for determining whether MPLS switching is required to be performed on an MPLS packet entering the MPLS packet interface board.

Step S03: Substitute the private MAC address for the destination public MAC address of the packet according to a MAC address mapping table.

Reference may be made to the above description. Additionally, if it is required by Layer-2 Forwarding, VLAN information can be packaged into the packet. For the selection of the private MAC address, the address range reserved in the MAC address, such as 8000-XXXX-XXXX, can be used. Such private addresses are only used for ether switching in a device, and will not be diffused outside of the device.

Step S04: the ether switch chip transfers the MPLS packet to the port to which the private MAC address is allocated, according to the private MAC address.

Step S05: the MPLS functional module corresponding to the private MAC address substitutes the destination public MAC address for the private MAC address in the MPLS data packet received.

If VLAN information is packaged when the packet enters the MPLS packet interface board, the VLAN is required to be unpackaged at this point, and then the packet is forwarded in normal forwarding process.

Step S06: send the MPLS packet via an outgoing interface.

Now, the processes in which an MPLS packet enters and exits an interface board according to embodiments of the invention will be described.

FIG. 4 shows a flow chart in which an MPLS packet enters an interface according to an embodiment of the invention, wherein:

If it is determined that MPLS label switching is not required to be performed on the MPLS packet, the outer-layer ether header and MPLS label is stripped off from the MPLS packet, so that the original ether packet can be sent to the ether chip for normal forwarding.

If it is determined that MPLS label switching is required to be performed on the MPLS packet, the private MAC address is searched according to the MAC address mapping table, and the private MAC address is substituted for the public MAC address in the MPLS packet. VLAN is packaged as required. Then, the packet is forwarded to the outgoing interface of the MPLS packet interface board via an ether switch chip (L2 chip).

FIG. 5 shows a flow chart in which an MPLS packet exits an interface according to an embodiment of the invention, wherein:

MPLS label switching is performed at first, and the public MAC address is substituted for the private MAC address. VLAN is unpackaged as required. Then, the packet is output.

Thus, in the embodiments of the invention, the private MAC address is packaged according to the destination public MAC address of an MPLS packet before the packet enters an ether switch chip. Then, the ether switch chip performs MPLS packet forwarding according to the private MAC address packaged. At this point, the MPLS packaging and the content of the packet in the MPLS package is transparent to the ether switch chip. As a result, various access interfaces and services of PWE3 can be supported via MPLS.

Additional advantages and modifications will readily occur to those skilled in the art. Therefore, the invention in its broader aspects is not limited to the specific details and representative embodiments shown and described herein. Accordingly, various variations and modifications may be made without departing from the spirit or scope of the invention as defined by the appended claims and their equivalents.

1. A method for forwarding an MPLS (Multi-Protocol Label Switching) packet in an ether switching device, comprising:
allocating a private MAC (Media Access Control) address to a port number of an MPLS packet interface board, and establishing a correlation between the private MAC address and a public MAC address;
obtaining a private MAC address and a port number corresponding to a destination public MAC address of an MPLS packet according to the correlation;
substituting the private MAC address for the public MAC address in the MPLS packet;
forwarding the MPLS packet to the corresponding port according to the private MAC address; and
substituting the destination public MAC address for the private MAC address in the MPLS packet, and forwarding the MPLS packet normally.

2. The method according to claim 1, wherein the process of establishing a correlation between the private MAC address and a public MAC address comprises:
configuring a mapping table of the port number, the private MAC address and the public MAC address.

3. The method according to claim 1, wherein: the private MAC address is a reserved MAC address.

4. The method according to claim 1, further comprising: determining whether MPLS label switching is required to be performed on the MPLS packet before substituting the private MAC address for the public MAC address in the MPLS packet, if yes, then performing the corresponding MAC address substitution; otherwise, forwarding the original ether packet normally.

5. The method according to claim 1, wherein: packaging VLAN (Virtual Local Area Network) information in the MPLS packet after the corresponding MAC address substitution is performed; and unpackaging the VLAN information from the MPLS packet after the public MAC address is substituted for the private MAC address in the MPLS packet.

6. A device for forwarding an MPLS packet, comprising:
an MPLS packet interface board, for providing a dedicated interface for MPLS packet forwarding;
a MAC address converting module, for performing conversion between the public MAC address in an MPLS packet that enters the MPLS packet interface board and the private MAC address in an ether switching device;
when an MPLS packet enters the ether switching device via the MPLS packet interface board, the MAC address converting module substitutes a private MAC address for a public MAC address in the MPLS packet, and an ether switch chip forwards the MPLS packet to a corresponding port according to the private MAC address; the MAC address converting module substitutes the destination public MAC address for the private MAC address in the MPLS packet, so as to forward it normally.

7. The device according to claim 6, wherein: the MAC address converting module is embedded in the MPLS packet interface board.

8. The device according to claim 6, wherein: the device further comprises an MPLS packet switching confirmation module, for confirming whether MPLS label switching is required to be performed on the MPLS packet.

9. The device according to claim 6, wherein the device further comprises:
a VLAN packaging module, for packaging VLAN information into an MPLS packet, and
a VLAN unpackaging module, for unpackaging the VLAN information packaged in the MPLS packet.

10. The device according to claim 6, wherein: the MPLS packet interface board has at least one service port, and each service port is configured with a MAC address.

11. The device according to claim 6, wherein: the MAC address is a private MAC address.

12. The device according to claim 6, wherein: the ether switch chip is a layer-2 ether switch chip or a layer-3 ether switch chip.

13. The device according to claim 7 wherein: the device further comprises an MPLS packet switching confirmation module, for confirming whether MPLS label switching is required to be performed on the MPLS packet.
